(19) United States
(12) Patent Application Publication
(10) Pub. No.: US 2024/0328180 A1
(43) Pub. Date: Oct. 3, 2024

(54) ADHESIVE APPLICATION SYSTEM

(71) Applicant: FASTBRICK IP PTY LTD, High Wycombe (AU)

(72) Inventor: Samuel Thomas Pickering, Kalamunda (AU)

(21) Appl. No.: 18/004,277

(22) PCT Filed: Jul. 8, 2021
(86) PCT No.: PCT/AU2021/050732

§ 371 Date: Jan. 4, 2023

(30) Foreign Application Priority Data
Jul. 8, 2020 (AU) 2020902367

(51) Int. Cl. E04G 21/22; B25J 15/00; B25J 18/02; E04G 21/20

(52) U.S. Cl. CPC E04G 21/22; B25J 15/0061; B25J 15/0066; B25J 15/008; B25J 18/025; E04G 21/20

(57) ABSTRACT

An adhesive application system for an automated block laying machine, the adhesive application system including: (a) an adhesive supply; and, (b) an adhesive applicator including: (i) a container for storing an adhesive reservoir received from the adhesive supply via an adhesive supply line; (ii) a lid mounted to the container so as to substantially cover the adhesive reservoir; and, (iii) an adhesive roller rotatably coupled to the container so that upon rotation adhesive from the reservoir is entrained up and around at least a portion of the adhesive roller, wherein, in use, adhesive is transferred from the adhesive roller onto a bottom surface of a block as the block is moved across the roller.

### CROSS-REFERENCE TO RELATED APPLICATION(S)

The present application claims priority from Australian Provisional Application No. 2020902367 titled “ADHESIVE APPLICATION SYSTEM” and filed on 8 Jul. 2020, the content of which is hereby incorporated by reference in its entirety.

### TECHNICAL FIELD

The present disclosure relates to an adhesive application system for an automated block laying machine. In a particular form, the system may be used to apply adhesive onto a brick or block, however the system may also be used to apply adhesive onto other construction materials such as roof tiles and the like.

### BACKGROUND

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

WO 2007/076581 describes an automated brick laying system for constructing a building from a plurality of bricks comprising a robot provided with a brick laying and adhesive applying head, a measuring system, and a controller that provides control data to the robot to lay the bricks at predetermined locations. The measuring system measures in real time the position of the head and produces position data for the controller. The controller produces control data on the basis of a comparison between the position data and a predetermined or pre-programmed position of the head to lay a brick at a predetermined position for the building under construction. The controller can control the robot to construct the building in a course by course manner where the bricks are laid sequentially at their respective predetermined positions and where a complete course of bricks for the entire building is laid prior to laying of the bricks for the next course.

A number of adhesive application systems suitable for use with robotic construction equipment have been contemplated by the present applicant. For example in PCT/AU2019/000102, there is provided an adhesive application system for an automated brick laying machine, the adhesive application system comprising an adhesive reservoir, an adhesive supply line extending from the reservoir to one or more nozzles configured to dispense adhesive, a first pump (a primary pump) positioned near to the reservoir, at least one further pump (secondary pump) positioned near to the or each of the nozzles, a supply line load cell positioned near to the or each secondary pump, and a control system, wherein in use, the control system controls operation of the primary pump in response to a supply pressure sensed at the supply line load cell. An adhesive applicator assembly is provided comprising a base, at least one nozzle carriage assembly, each nozzle carriage assembly comprising a carriage, and at least one adhesive outlet nozzle depending from the carriage, for dispensing adhesive received from a supply of adhesive via an adhesive supply line, and a transverse drive means for driving the or each nozzle carriage assembly transversely relative to the base. The above described arrangement is a top-down pump system in which adhesive is pumped down onto an upward facing side of a brick so that gravity assists in applying adhesive to the brick.

The adhesive application system described in PCT/AU2019/000102 including the adhesive supply is co-located at the brick laying and adhesive applying head. This arrangement is in contrast to the system described in PCT/AU2017/050728, in which an adhesive container and pump was located proximate the chassis of a truck that provides the base of the automated brick laying machine and the adhesive was pumped out along the boom to an adhesive applicator mounted to the brick laying and adhesive applying head. The adhesive applicator in this system comprised an applicator head with nozzles supported on a distal end of a tongue member, said tongue member being housed in a sheath for linear movement to extend said adhesive applicator head across the surface of a brick for application of adhesive.

It is desirable to develop an adhesive application system for an automated block laying machine that provides an alternative to a top-down pumping system. In a top-down pumping system, dispensing adhesive in a metered dose can be difficult due to varying viscosity of the adhesive with temperature. As adhesive is applied to a top face of the block, it must be rotated before it is laid which can induce the adhesive to drip from the block. Furthermore, applying adhesive with nozzles can be difficult on blocks with complex grid/core structures. It would also be advantageous to reduce design complexity, part count and running costs whilst increasing adhesive application speed.

It is against this background and the problems and difficulties associated therewith that the present invention has been developed.

Other objects and advantages of the present invention will become apparent from the following description, taken in connection with the accompanying drawings, wherein, by way of illustration and example, at least one embodiment of the present invention is disclosed.

### SUMMARY

In one broad form, an aspect of the present invention seeks to provide an adhesive application system for an automated block laying machine, the adhesive application system including:
a) an adhesive supply; and,
b) an adhesive applicator including:
   i) a container for storing an adhesive reservoir received from the adhesive supply via an adhesive supply line;
   ii) a lid mounted to the container so as to substantially cover the adhesive reservoir; and,
   iii) an adhesive roller rotatably coupled to the container and configured to be at least partially submerged in the adhesive reservoir so that upon rotation adhesive from the reservoir is entrained up and around at least a portion of the adhesive roller,
wherein, in use, adhesive is transferred from the adhesive roller onto a bottom surface of a block as the block is moved across the roller.

In one embodiment, adhesive is provided to the adhesive applicator from the adhesive supply via a gravity feed.

In one embodiment, the adhesive supply is a canister having:
a) an opening to allow the canister to be at least partially filled with adhesive; and,
b) a removable cap that seals the opening and is configured to be in fluid communication with the adhesive supply line;
wherein, in use, the canister is oriented so that the cap is facing downward and adhesive is able to flow by gravity through the cap and into the supply line.

In one embodiment, the adhesive supply line includes a valve which is openable to allow flow of adhesive into the container of the adhesive applicator.

In one embodiment, the valve is actuated by a motor and controllable to selectively open in order to meter the amount of adhesive supplied to the container.

In one embodiment, the motor is coupled to a reduction gearbox to increase torque for actuating the valve.

In one embodiment, the amount of adhesive in the container is monitored by at least one of:
a) a level sensor that provides a signal to a controller indicative of the level of adhesive in the container; and,
b) a mass sensor that provides a signal to a controller indicative of the mass of the container.

In one embodiment, the level sensor is a capacitive sensor mounted to the side of the container.

In one embodiment, the mass sensor is a load cell mounted beneath the container.

In one embodiment, the adhesive is heated prior to application.

In one embodiment, a heating element is provided at the base of the container.

In one embodiment, the adhesive roller includes:
a) an elongate shaft having axles rotatably coupled to opposing ends of the container; and,
b) one or more roller elements coupled to or integral with the shaft.

In one embodiment, in use, the one or more roller elements are at least partially submerged in the adhesive reservoir.

In one embodiment, the one or more roller elements at least partially protrude above the lid through openings therein.

In one embodiment, the one or more roller elements are circular discs or wheels.

In one embodiment, the one or more roller elements have at least one circumferential groove formed therein.

In one embodiment, the adhesive roller is driven by a motor coupled to the elongate shaft via a coupling element.

In one embodiment, a bead of adhesive is entrained onto the one or more roller elements as the shaft rotates and is transferred onto the block as the block moves across the adhesive roller, wherein one of:
a) the block contacts the one or more roller elements; and,
b) there is a gap between the block and the one or more roller elements less than or equal to the thickness of the bead of adhesive.

In one embodiment, the system is mounted to a block laying and adhesive applying head of the automated block laying machine, the head located at a distal end of a telescopingly extendable and foldable boom for conveying blocks therealong.

In one embodiment, the adhesive applicator is adjustably mounted to the head via a support post and bracket.

In another broad form, an aspect of the present invention seeks to provide a block laying and adhesive applying head for an automated block laying machine, the head mountable to a distal end of a telescopingly extendable and foldable boom for conveying blocks therealong, the head including an adhesive application system including:
a) an adhesive supply; and,
b) an adhesive applicator including:
   i) a container for storing an adhesive reservoir received from the adhesive supply via an adhesive supply line;
   ii) a lid mounted to the container so as to substantially cover the adhesive reservoir; and,
   iii) an adhesive roller rotatably coupled to the container and configured to be at least partially submerged in the adhesive reservoir so that upon rotation adhesive from the reservoir is entrained up and around at least a portion of the adhesive roller,
wherein, in use, adhesive is transferred from the adhesive roller onto a bottom surface of a block as the block is moved across the roller.

In one embodiment, the head includes a block transfer apparatus for transferring a block from a distal end of the boom to a robotic arm having an end effector which grips and lays the block at a predetermined spatial position and orientation, the block transfer apparatus configured to clamp the block and linearly extend it across the adhesive roller before it is transferred to the robotic arm and laid.

In another broad form, an aspect of the present invention seeks to provide a block laying and adhesive applying head for an automated block laying machine, the head mountable to a distal end of a telescopingly extendable and foldable boom for conveying blocks therealong, the head including:
a) a support mountable to the boom;
b) a robotic arm having an end effector operable to grip and lay blocks at a predetermined spatial position and orientation;
c) a block transfer apparatus for transferring a block from the distal end of the boom to the robotic arm; and,
d) an adhesive application system mounted to the support including:
   i) an adhesive supply; and,
   ii) an adhesive applicator including:
      (1) a container for storing an adhesive reservoir received from the adhesive supply via an adhesive supply line;
      (2) a lid mounted to the container so as to substantially cover the adhesive reservoir; and,
      (3) an adhesive roller rotatably coupled to the container and configured to be at least partially submerged in the adhesive reservoir so that upon rotation adhesive from the reservoir is entrained up and around at least a portion of the adhesive roller,
wherein, in use, adhesive is transferred from the adhesive roller onto a bottom surface of a block as the block transfer apparatus linearly extends a block across the roller.

In yet a further broad form, an aspect of the present invention seeks to provide an automated block laying machine, including:
a) a base;
b) a telescopingly extendable and foldable boom rotatably mounted from the base for conveying blocks therealong; and,
c) a block laying and adhesive applying head, the head mountable to a distal end of the boom, the head including:
   i) a support mountable to the boom;
   ii) a robotic arm having an end effector operable to grip and lay blocks at a predetermined spatial position and orientation;
   iii) a block transfer apparatus for transferring a block from the distal end of the boom to the robotic arm; and,
   iv) an adhesive application system mounted to the support including:
      (1) an adhesive supply; and,
      (2) an adhesive applicator including:
         (a) a container for storing an adhesive reservoir received from the adhesive supply via an adhesive supply line;
         (b) a lid mounted to the container so as to substantially cover the adhesive reservoir; and,
         (c) an adhesive roller rotatably coupled to the container and configured to be at least partially submerged in the adhesive reservoir so that upon rotation adhesive from the reservoir is entrained up and around at least a portion of the adhesive roller,
wherein, in use, adhesive is transferred from the adhesive roller onto a bottom surface of a block as the block transfer apparatus linearly extends a block across the roller.

In another broad form, an aspect of the present invention seeks to provide an adhesive application system for use in an automated block laying machine, the adhesive application system including:
a) an adhesive supply; and,
b) an adhesive applicator including:
   i) a container for storing an adhesive reservoir received from the adhesive supply via an adhesive supply line;
   ii) a pair of sprung roller arms coupled to the container for supporting an adhesive roller; and,
   iii) an adhesive roller rotatably coupled to the sprung roller arms and configured to extend across the container, the adhesive roller at least partially submerged in the adhesive reservoir so that upon rotation adhesive from the reservoir is entrained up and around the roller;
wherein, in use, adhesive is transferred from the adhesive roller onto a bottom surface of a block as the block is moved across the roller.

In one embodiment, the pair of sprung roller arms form part of a lid that at least partly conceals the adhesive reservoir in the container.

In one embodiment, the pair of sprung roller arms are disposed about opposing sides of the container.

In one embodiment, the pair of sprung roller arms include a groove or slot into which an axle of the adhesive roller is rotatably coupled.

In one embodiment, the sprung roller arms are coupled to the container by an integral moulding that includes a built-in hinge or pivot that allows the arms to flex.

In one embodiment, the adhesive roller has an elongate body having a plurality of circumferential grooves spaced apart along the length of the body.

In one embodiment, the adhesive roller includes:
a) an elongate shaft; and,
b) a plurality of spaced apart roller elements coupled to the shaft.

In one embodiment, the roller elements are cylindrical and include a plurality of circumferential grooves.

In one embodiment, the roller elements are spaced apart by spacer elements.

In one embodiment, the adhesive roller includes alternating roller and spacer elements coupled to the shaft and wherein the spacer elements have a diameter less than the roller elements.

In one embodiment, the adhesive applicator further includes a scraper coupled to the pair of sprung roller arms proximate a distal end thereof, the scraper having an elongate body defining:
a) one or more ridged sections including a plurality of ridges operable to block particular grooves of the adhesive roller and scrape adhesive therefrom; and,
b) one or more voids positioned between the ridged sections, the voids providing areas where adhesive is able to be entrained onto the roller to thereby define a pre-defined adhesive signature.

In one embodiment, the scraper is removably mounted to the roller arms.

In one embodiment, the scraper is urged beneath tabs located along a lengthwise edge of the lid so as to pre-tension the pair of sprung roller arms.

In one embodiment, the container is mounted in a cradle.

In one embodiment, a heated plate is mounted to the base of the cradle and the container is mounted onto the heated plate so as to control the temperature of the adhesive in the reservoir.

In one embodiment, a load cell is positioned beneath the cradle and used to monitor the weight of the adhesive in the reservoir so as to maintain a programmed level of adhesive in the reservoir.

In one embodiment, the lid further includes a pivotable cover disposed between the pair of sprung roller arms and extending towards the adhesive roller, a distal end of the pivotable cover urged beneath tabs disposed on the sprung roller arms so as to allow any adhesive on the surface of the cover to drain back into the reservoir.

In one embodiment, adhesive from the adhesive supply is pumped into the container via a peristaltic pump.

In one embodiment, the pump is one of:
a) servo controlled; and,
b) a linear peristaltic pump comprised of multiple pinch valves.

In one embodiment, the system is mounted to a block laying and adhesive applying head of the automated block laying machine, the head located at a distal end of a telescopingly extendable and foldable boom for conveying blocks therealong.

In one embodiment, the adhesive applicator is adjustably mounted to the head via a support post and bracket.

In another broad form, an aspect of the present invention seeks to provide a block laying and adhesive applying head for an automated block laying machine, the head mountable to a distal end of a telescopingly extendable and foldable boom for conveying blocks therealong, the head including an adhesive application system including:
a) a container for storing an adhesive reservoir received from the adhesive supply via an adhesive supply line;
b) a pair of sprung roller arms coupled to the container for supporting an adhesive roller; and,
c) an adhesive roller rotatably coupled to the sprung roller arms and configured to extend across the container, the adhesive roller at least partially submerged in the adhesive reservoir so that upon rotation adhesive from the reservoir is entrained up and around the roller;
wherein, in use, adhesive is transferred from the adhesive roller onto a bottom surface of a block as the block is moved across the roller.

In one embodiment, the head includes a block transfer apparatus for transferring a block from a distal end of the boom to a robotic arm having an end effector which grips and lays the block at a predetermined spatial position and orientation, the block transfer apparatus configured to clamp the block and linearly extend it across the adhesive roller before it is transferred to the robotic arm and laid.

In another broad form, an aspect of the present invention seeks to provide a block laying and adhesive applying head for an automated block laying machine, the head mountable to a distal end of a telescopingly extendable and foldable boom for conveying blocks therealong, the head including:
a) a support mountable to the boom;
b) a robotic arm having an end effector operable to grip and lay blocks at a predetermined spatial position and orientation;
c) a block transfer apparatus for transferring a block from the distal end of the boom to the robotic arm; and,
d) an adhesive application system mounted to the support including:
   i) a container for storing an adhesive reservoir received from the adhesive supply via an adhesive supply line;
   ii) a pair of sprung roller arms coupled to the container for supporting an adhesive roller;
   iii) an adhesive roller rotatably coupled to the sprung roller arms and configured to extend across the container, the adhesive roller at least partially submerged in the adhesive reservoir so that upon rotation adhesive from the reservoir is entrained up and around the roller;
wherein, in use, adhesive is transferred from the adhesive roller onto a bottom surface of a block as the block transfer apparatus linearly extends a block across the roller.

In another broad form, an aspect of the present invention seeks to provide an automated block laying machine, including:
a) a base;
b) a telescopingly extendable and foldable boom rotatably mounted from the base for conveying blocks therealong; and,
c) a block laying and adhesive applying head, the head mountable to a distal end of the, the head including:
   i) a support mountable to the boom;
   ii) a robotic arm having an end effector operable to grip and lay blocks at a predetermined spatial position and orientation;
   iii) a block transfer apparatus for transferring a block from the distal end of the boom to the robotic arm; and,
   iv) an adhesive application system mounted to the support including:
      (1) an adhesive supply; and,
      (2) an adhesive applicator, including:
         (a) a container for storing an adhesive reservoir received from the adhesive supply via an adhesive supply line;
         (b) a pair of sprung roller arms coupled to the container for supporting an adhesive roller; and,
         (c) an adhesive roller rotatably coupled to the sprung roller arms and configured to extend across the container, the adhesive roller at least partially submerged in the adhesive reservoir so that upon rotation adhesive from the reservoir is entrained up and around the roller;
wherein, in use, adhesive is transferred from the adhesive roller onto a bottom surface of a block as the block transfer apparatus linearly extends a block across the roller.

In another broad form, an aspect of the present invention seeks to provide an adhesive application system for an automated block laying machine, the adhesive application system including:
a) an adhesive supply;
b) an adhesive applicator including:
   i) a container for storing an adhesive reservoir received from the adhesive supply via an adhesive supply line;
   ii) a lid mounted to the container so as to substantially cover the adhesive reservoir; and,
   iii) an adhesive roller rotatably coupled to the lid so that upon rotation adhesive from the reservoir is entrained up and around the roller,
wherein, in use, adhesive is transferred from the adhesive roller onto a bottom surface of a block as the block is moved across the roller.

It will be appreciated that the broad forms of the invention and their respective features can be used in conjunction and/or independently, and reference to separate broad forms is not intended to be limiting. Furthermore, it will be appreciated that features of the method can be performed using the system or apparatus and that features of the system or apparatus can be implemented using the method.

### BRIEF DESCRIPTION OF THE DRAWINGS

Various examples and embodiments of the present invention will now be described with reference to the accompanying drawings, in which: —

FIG. 1A is an upper perspective view of an example of an adhesive application system for an automated block laying machine;

FIG. 1B is a lower perspective view of the adhesive application system of FIG. 1A;

FIG. 1C is a top view of the adhesive application system of FIG. 1A;

FIG. 1D is a front view of the adhesive application system of FIG. 1A showing a block disposed above the applicator;

FIG. 1E is a cross-sectional view taken through section A-A of FIG. 1C showing the adhesive roller drive system;

FIG. 1F is a cross-sectional view taken through section B-B of FIG. 1C showing the adhesive supply line valve actuation system;

FIG. 2A is an upper perspective view of the adhesive application system of FIG. 1A showing a disposable trip tray and bump plate incorporated into the system;

FIG. 2B is an upper perspective view of the adhesive application system of FIG. 2A showing an outer enclosure fitted to the system;

FIGS. 3A and 3B provide respective side and perspective views of a block laying and adhesive applying head and part of a boom assembly of an automated block laying machine including the adhesive application system of FIG. 1A;

FIG. 4A is a perspective view of an example of an adhesive applicator of the adhesive application system of FIG. 1A;

FIG. 4B is an exploded view of the adhesive applicator of FIG. 4A;

FIG. 5A is a perspective view of an example of an adhesive application system for an automated block laying machine;

FIG. 5B is a cross-sectional view of the adhesive application system of FIG. 5A taken through a sprung roller arm of the adhesive applicator;

FIG. 6A is a front view of the adhesive applicator of FIG. 5A;

FIG. 6B is a perspective view of the adhesive applicator of FIG. 5A;

FIG. 6C is a top view of the adhesive applicator of FIG. 5A;

FIG. 7 is a top view of a scraper for use with the adhesive applicator;

FIG. 8 is a cross-sectional view of the adhesive applicator;

FIG. 9A is a lower perspective view of a lid of the adhesive applicator;

FIG. 9B is a cross-sectional view of the lid of FIG. 9A;

FIG. 9C is a cross-sectional view of the lid of FIG. 9A with drain element pushed down;

FIG. 9D is a cross-sectional view of the lid of FIG. 9A showing a sprung roller arm pushed down to provide a pre-load when the roller is in contact with the block;

FIG. 10A is a further perspective view of the adhesive application system of FIG. 5A;

FIG. 10B is a cross-sectional view of the adhesive application system taken through the load cell beneath the adhesive applicator;

FIGS. 11A to 11H provide a sequence of views illustrating a block moving across the roller to thereby apply adhesive to the bottom surface of the block;

FIGS. 12A to 12C show photographs of example adhesive signatures applied to a variety of block geometries;

FIGS. 13A and 13B are perspective views of an automated block laying machine showing a boom in folded and extended positions;

FIG. 14 is a perspective view of a block laying and adhesive applying head of an automated block laying machine including the adhesive application system of FIG. 1A;

FIGS. 15A to 15C illustrate a sequence of perspective views of the block laying and adhesive applying head of FIG. 14 extending a block across the roller of the adhesive applicator;

FIG. 16 is a schematic side view of an adhesive applicator having a self-priming system;

FIG. 17A is a schematic top view of a further example of an adhesive roller;

FIG. 17B is a schematic top view of a further example of an adhesive roller;

FIG. 17C is a schematic top view of a further example of an adhesive roller;

FIG. 17D is a schematic top view of a further example of an adhesive roller;

FIG. 17E is a schematic top view of yet a further example of an adhesive roller; and,

FIG. 17F is a schematic top view of the adhesive roller of FIG. 17E shown beneath a lid which masks the leading edge of the roller.

### DETAILED DESCRIPTION

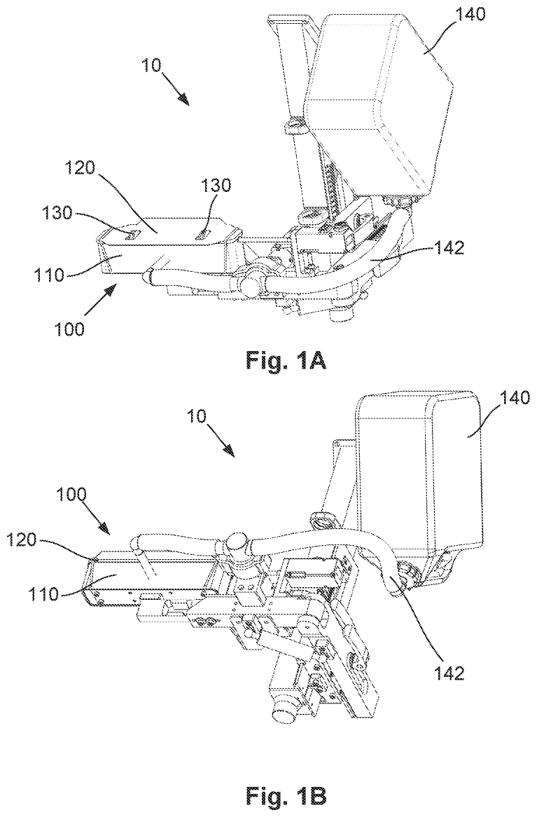

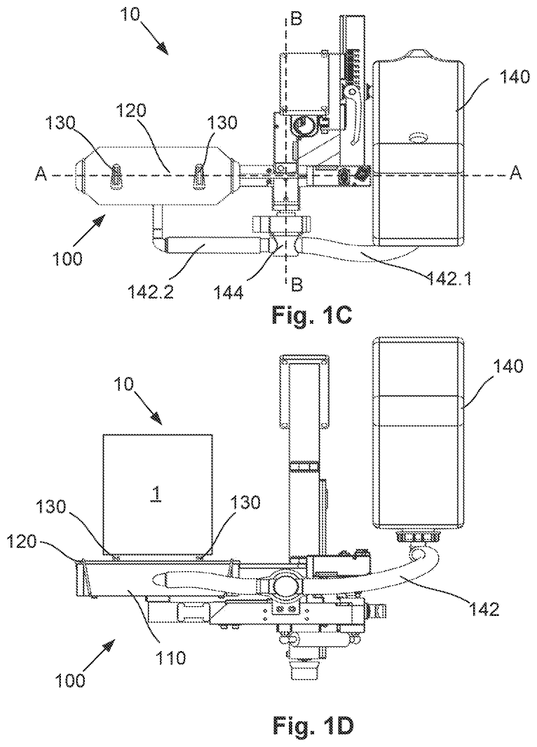

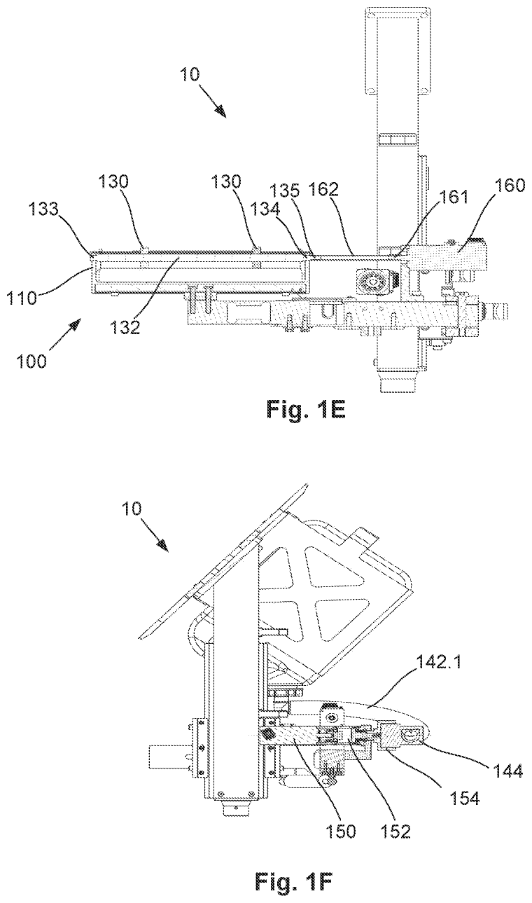

An example of an adhesive application system 10 for an automated block laying machine will now be described with reference to FIG. 1A.

In this example, the system 10 includes an adhesive supply 140 and an adhesive applicator 100 including a container 110 for storing an adhesive reservoir received from the adhesive supply 140 via an adhesive supply line 142 and a lid 120 mounted to the container 110 so as to substantially cover the adhesive reservoir.

The adhesive applicator 100 further includes an adhesive roller 130 rotatably coupled to the container 110 and configured to be at least partially submerged in the adhesive reservoir so that upon rotation, adhesive from the reservoir is entrained up and around at least a portion of the adhesive roller 130. In use, adhesive is transferred from the adhesive roller onto a bottom surface of a block as the block is moved across the roller.

In accordance with the above-described arrangement, adhesive is applied to blocks in a bottom-up manner as opposed to a top-down pumping arrangement in which nozzles dispense adhesive onto the top surface of the block. In a top-down pumping arrangement, before a block can be laid, it must be flipped over so that the surface with adhesive is facing down. During this flipping motion, the adhesive is often prone to dripping which may lead to wastage, inadequate coverage on the block and contamination of the building site. The above-described adhesive application system 10 alleviates this problem and tends to minimise dripping as the block is not required to be rotated after adhesive application.

A roller-based adhesive application system eliminates many parts of a top-down pumping arrangement including pumps, nozzles, nozzle carriages, drives, gears etc. This reduces design complexity and cost. Furthermore, applying adhesive with a roller provides a more consistent and repeatable adhesive signature as less variables (such as line pressure, pump speed etc.) need to be controlled compared to a nozzle-based applicator. A pump-based system can have difficulties dispensing adhesive in a metered dose due to varying viscosity with temperature that can make pumping more difficult. The roller-based system overcomes this issue since adhesive is simply transferred from the roller onto the block as it moves across the roller.

In addition, a roller-based system allows adhesive to be applied easily onto blocks that may have a complex grid or core structure (such as Porotherm clay blocks) as the roller simply transfers adhesive onto adjacent web structures as the block is moved across the roller, whereas a nozzle application would lead to adhesive being dispensed into cores making it more difficult to achieve consistent coverage.

A number of further examples will now be described.

There are different ways in which adhesive may flow from the adhesive supply to the container of the adhesive applicator via the supply line in order to maintain a desired level in the container for continuous application. In one example, adhesive is provided to the adhesive applicator from the adhesive supply via a gravity feed.

In this example, the adhesive supply is a canister having an opening to allow the canister to be at least partially filled with adhesive; and, a removable cap that seals the opening and is configured to be in fluid communication with the adhesive supply line; wherein, in use, the canister is oriented so that the cap is facing downward and adhesive is able to flow by gravity through the cap and into the supply line. The term canister refers to any suitable type of container, drum or storage vessel that can store the construction adhesive. Typically, it is made from an industrial strength, heavy duty, durable high density polyethylene (HDPE) or similar plastic.

The adhesive supply could take numerous forms including also an adhesive cartridge as described in co-pending application PCT/AU2019/000103 (hereby incorporated by reference) which comprises a bladder for the adhesive, a shell for the bladder, the shell comprising an aperture therethrough, and at least one valve assembly for controlling adhesive flow, the valve assembly comprising a valve body, at least a portion of which extends through the aperture and into the shell.

In an alternative arrangement such as one using the adhesive cartridge as described in co-pending application PCT/AU2019/000103, adhesive from the adhesive supply is pumped into the container via a peristaltic pump. The pump may be servo controlled. Alternatively, in a simpler arrangement a linear peristaltic pump may be used comprising multiple pinch valves which regulate the amount of adhesive pumped into the container.

In respect of the gravity feed system, typically the adhesive supply line includes a valve which is openable to allow flow of adhesive into the container of the adhesive applicator. The valve may be actuated by a motor and controllable to selectively open in order to meter the amount of adhesive supplied to the container in order to maintain a desired level.

Depending on the valve used and torque required to reliability open and close it, in some examples the motor is coupled to a reduction gearbox to increase torque for actuating the valve.

In order to prevent overfilling of the container and also to ensure a sufficient amount of adhesive is in the reservoir for application, the amount of adhesive in the container is constantly monitored. In one example, the amount of adhesive in the container is monitored by at least one of: a level sensor that provides a signal to a controller indicative of the level of adhesive in the container; and, a mass sensor that provides a signal to a controller indicative of the mass of the container.

The level sensor may be a capacitive sensor mounted to the side of the container whereas the mass sensor may be a load cell that is mounted beneath the container to measure the mass thereof.

In another example, a non-contact ultrasonic sensor to measure distance to the top of the adhesive in the container may be used.

In order to optimise adhesive application in all operating environments, it is preferable to heat the adhesive prior to application. This may be achieved by adding a heating element in the base of the container which assists in controlling the viscosity of the fluid.

The adhesive roller itself typically includes an elongate shaft having axles rotatably coupled to opposing ends of the container, and, one or more roller elements coupled to or integral with the shaft. In use, it is the one or more roller elements are at least partially submerged in the adhesive reservoir. The roller elements may be in the shape of circular discs or wheels and preferably with at least one circumferential groove formed therein which assists in entraining a bead of adhesive onto the or each roller element. The roller elements may vary in number and spacing to accommodate desired adhesive signature patterns for different block types and geometries.

In order to transfer adhesive onto the block, the one or more roller elements at least partially protrude above the lid through openings therein.

In one example, the adhesive roller is driven by a motor coupled to the elongate shaft via a coupling or transmission element. In its simplest form, the coupling element may just be a short length of polyvinyl chloride (PVC) tubing that sheaths over the end of the motor shaft at one end and over the shaft of the roller at the other. Driving the roller in this manner is advantageous as it provides a form of self-priming to the system ensuring that adhesive is always entrained onto the roller whenever a block moves across it. This ensures consistent application along the entire length of the block.

Typically, a bead of adhesive is entrained onto the one or more roller elements as the shaft rotates and is transferred onto the block as the block moves across the adhesive roller. Whilst in some implementations the block physically contacts the one or more roller elements as it moves across, this is not necessary and a gap between the block and the one or more roller elements may be provided that is less than or equal to the thickness of the bead of adhesive entrained on the roller elements.

In one example, the system is mounted to a block laying and adhesive applying head of the automated block laying machine, the head located at a distal end of a telescopingly extendable and foldable boom for conveying blocks therealong. The adhesive application may be adjustably mounted to the head via a support post and bracket to permit the applicator to be height adjusted to suit different block geometries and also in some embodiments adjusted laterally or longitudinally.

In another broad form, an aspect of the present invention seeks to provide a block laying and adhesive applying head for an automated block laying machine, the head mountable to a distal end of a telescopingly extendable and foldable boom for conveying blocks therealong, the head including an adhesive application system including: an adhesive supply; and, an adhesive applicator including: a container for storing an adhesive reservoir received from the adhesive supply via an adhesive supply line; a lid mounted to the container so as to substantially cover the adhesive reservoir; and, an adhesive roller rotatably coupled to the container and configured to be at least partially submerged in the adhesive reservoir so that upon rotation adhesive from the reservoir is entrained up and around at least a portion of the adhesive roller, wherein, in use, adhesive is transferred from the adhesive roller onto a bottom surface of a block as the block is moved across the roller.

In one example, the head includes a block transfer apparatus as described in applicant's co-pending application PCT/AU2021/050361 for transferring a block from a distal end of the boom to a robotic arm having an end effector which grips and lays the block at a predetermined spatial position and orientation, the block transfer apparatus configured to clamp the block and linearly extend it across the adhesive roller before it is transferred to the robotic arm and laid.

In another broad form, an aspect of the present invention seeks to provide a block laying and adhesive applying head for an automated block laying machine, the head mountable to a distal end of a telescopingly extendable and foldable boom for conveying blocks therealong, the head including: a support mountable to the boom; a robotic arm having an end effector operable to grip and lay blocks at a predetermined spatial position and orientation; a block transfer apparatus for transferring a block from the distal end of the boom to the robotic arm; and, an adhesive application system mounted to the support including: an adhesive supply; and, an adhesive applicator including: a container for storing an adhesive reservoir received from the adhesive supply via an adhesive supply line; a lid mounted to the container so as to substantially cover the adhesive reservoir; and, an adhesive roller rotatably coupled to the container and configured to be at least partially submerged in the adhesive reservoir so that upon rotation adhesive from the reservoir is entrained up and around at least a portion of the adhesive roller, wherein, in use, adhesive is transferred from the adhesive roller onto a bottom surface of a block as the block transfer apparatus linearly extends a block across the roller.

In yet a further broad form, an aspect of the present invention seeks to provide an automated block laying machine, including: a base; a telescopingly extendable and foldable boom rotatably mounted from the base for conveying blocks therealong; and, a block laying and adhesive applying head, the head mountable to a distal end of the boom, the head including: a support mountable to the boom; a robotic arm having an end effector operable to grip and lay blocks at a predetermined spatial position and orientation; a block transfer apparatus for transferring a block from the distal end of the boom to the robotic arm; and, an adhesive application system mounted to the support including: an adhesive supply; and, an adhesive applicator including: a container for storing an adhesive reservoir received from the adhesive supply via an adhesive supply line; a lid mounted to the container so as to substantially cover the adhesive reservoir; and, an adhesive roller rotatably coupled to the container and configured to be at least partially submerged in the adhesive reservoir so that upon rotation adhesive from the reservoir is entrained up and around at least a portion of the adhesive roller, wherein, in use, adhesive is transferred from the adhesive roller onto a bottom surface of a block as the block transfer apparatus linearly extends a block across the roller.

The adhesive application system 10 shall now be described in further detail.

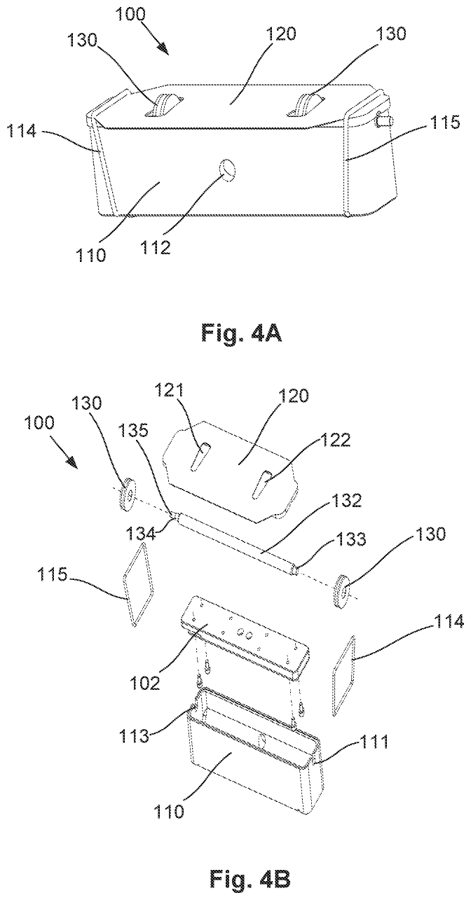

As shown in FIGS. 4A to 4B, the adhesive applicator 100 comprises a rectangular container 110 with an aperture 112 in a side thereof which provides an inlet for a fitting of the adhesive supply line 142 in order for adhesive to be metered into the container 110. The container 110 has slots 111, 113 in the ends thereof which receive ends 133, 134 of the elongate shaft 132 of the adhesive roller. In this example a pair of roller elements 130 in the form of circular discs with a slotted circumference are coupled to the shaft 132.

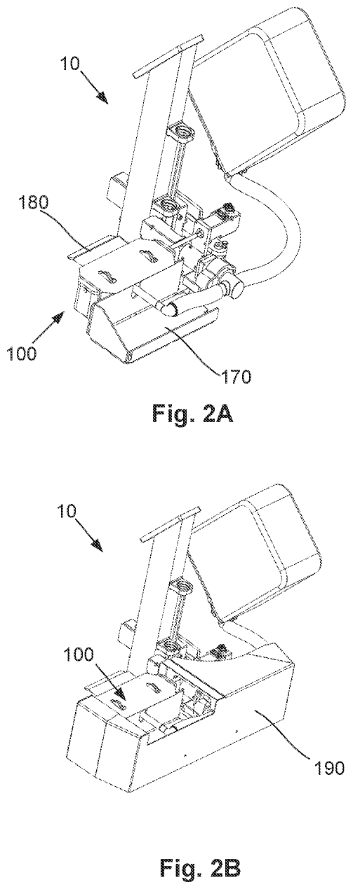

A lid 120 presses onto the top of the container 110, the lid 120 having a pair of spaced apart slots 121, 122 through which the adhesive rollers 130 protrude in operation. A pair of elastic bands or straps 114, 115 may assist in securing the lid 120 to the container 110 as shown. The lid may have flared sides which overhang the container to assist in directing any adhesive spill into catchment areas. For example, as shown in FIG. 2A, a disposable drip tray 170 may be located in front of the adhesive applicator to catch any overfill and drips from the bottom of a block as it is being moved across the applicator.

The container 110 is mounted onto a heating plate 102 which is screwed underneath the container for controlling the temperature (and viscosity) of the adhesive in the container before it is applied.

Referring now to FIGS. 1C, 1E and 1F, further detail of actuation of the adhesive roller 130 and supply line valve 144 shall be described. In FIG. 1E, there is shown a sectional view through the adhesive roller shaft 132. Servo motor 160 drives this shaft 132 via a coupling element 162 which connects the motor shaft 161 and axle 135 of the roller shaft 132. In this way, the roller 130 can be primed and always ready to transfer a reliable bead of adhesive onto a block. The rotational speed of the roller 130 can be varied in accordance with a datafile which defines this parameter in order to ensure a reliable and repeatable application.

In an alternative example such as shown in FIG. 16, a system 700 may be configured so that the block 1 may move across a roller or gear 734 which turns connecting gear 732 and then primes the adhesive roller 730 so that when the block 1 passes over the applicator, a bead of adhesive is already entrained onto the roller 730. In this example, the block itself primes the system and no motor is necessary (i.e. the adhesive roller does not need to be motor driven).

Adhesive supply line valve 144 connects a first supply line segment 142.1 (between the supply 140 and valve 144) with a second supply line segment 142.2 (between the valve 144 and container 110). Adhesive from the supply 140 flows into first supply line segment 142.1 by gravity and is then metered into the second supply line segment 142.2 which flows into container 110 when the valve 144 is open. The valve 144 is pressed into a fitting 154 which has a complementary shape to the exterior of the valve body. The fitting 154 is actuated by a servo motor 150 via a reduction gearbox 152 which increases the torque output of the motor 150 so as to be able to rotate the fitting 154 and thereby open and close the valve 144.

In operation, a capacitive sensor mounted to the container 110 senses a level of adhesive therein and the valve 144 is then controlled in order to meter the appropriate amount of adhesive into the container 110.

Additional features which the adhesive application system 10 may have include a metal bump plate 180 installed to the rear of the adhesive applicator 100 slightly lower than the rollers 130 so that if the block is transferred lower than expected, it will contact the bump plate 180 instead of crashing into the applicator and causing damage to the system. The system may further include an outer enclosure 190 which provides a cover for part of the system and provides further protection to components especially to prevent any unwanted adhesive spill onto other parts of the system.

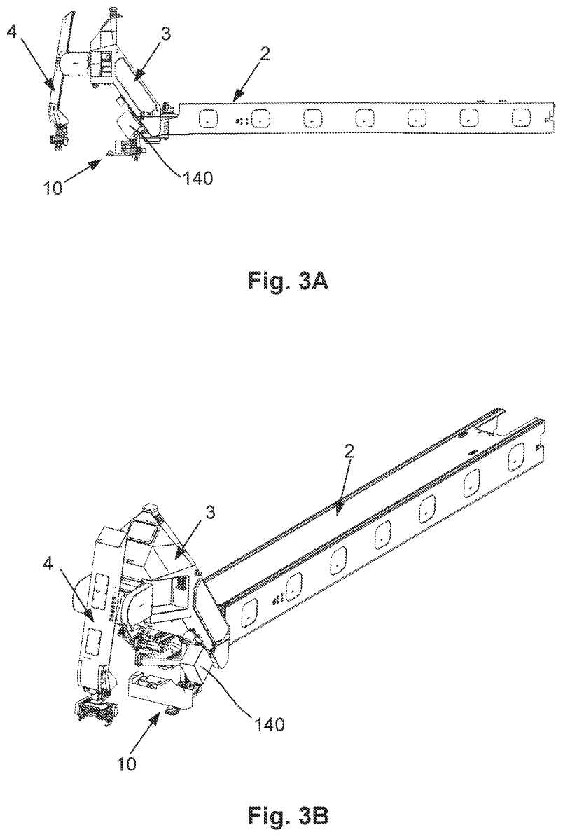

The adhesive application system 10 is installed onto a block laying and adhesive applying head 3 of an automated block laying robot as depicted in FIGS. 3A and 3B. The head 3 is mountable to a distal end of a telescopingly extendable and foldable boom 2 for conveying blocks therealong. A block transfer apparatus clamps a block received from a shuttle in the boom and extends the block across the adhesive applicator and then a laying arm picks up the block and places it at a desired position. The adhesive supply 140 is removably mounted to the side of the head 3 and the adhesive applicator assembly is mounted from the head by a support post.

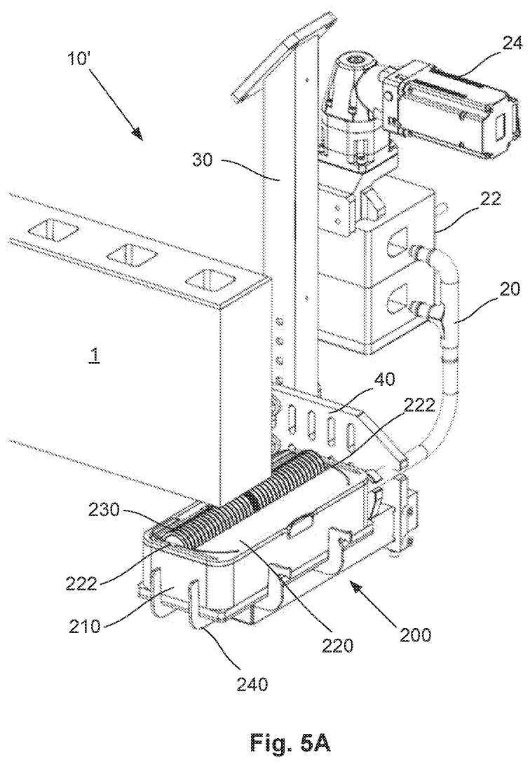

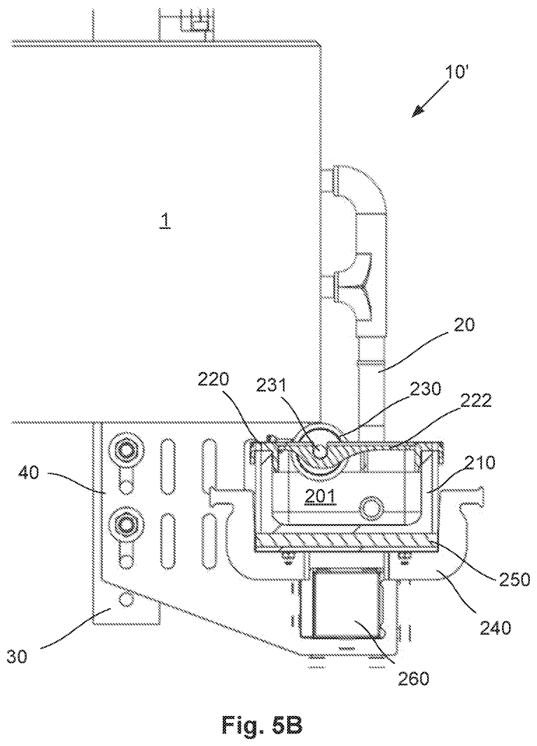

Another example of an adhesive application system 10′ is shown in FIGS. 5A and 5B.

In this example, the system 10′ includes an adhesive supply (not shown) and an adhesive applicator 200 including a container 210 for storing an adhesive reservoir 201 received from the adhesive supply via an adhesive supply line 20, a pair of sprung roller arms 222 coupled to the container 210 for supporting an adhesive roller 230. The adhesive roller 230 is rotatably coupled to the sprung roller arms 222 and is configured to extend across the container 210. The adhesive roller 230 is at least partially submerged in the adhesive reservoir 201 so that upon rotation, adhesive from the reservoir 201 is entrained up and around the roller 230. In use, adhesive is transferred from the adhesive roller 230 onto a bottom surface of a block 1 as the block 1 is moved across the roller 230.

The adhesive supply could take numerous forms as previously described such as the adhesive cartridge described in co-pending application PCT/AU2019/000103. Typically, adhesive from the adhesive supply is pumped into the container 210 via a peristaltic pump 22 and supply line 20. The pump 22 may be actuated by a servo motor 24 as shown in FIG. 5A. Alternatively, in a simpler arrangement a linear peristaltic pump may be used comprising multiple pinch valves which regulate the amount of adhesive pumped into the container.

The term “sprung roller arms” shall be understood to refer to flexible or compliant arms which support the adhesive roller and which are adapted to bend or flex under load about a pivot or hinge so as to induce positive contact between the roller and block in use. The arms could be plastic or metal leaf spring arms that are integrally moulded or formed with a lid or container cover, or alternatively formed part of components which engage onto the container but may not necessarily cover the container. The arms may be separate components, an integral component or otherwise connected together.

In this example, the pair of sprung roller arms 222 form part of a lid or cover 220 that at least partly conceals the adhesive reservoir 201 in the container 210. In this regard, it is generally desirable to cover the adhesive so as to prevent it from curing when exposed to air or humidity. In this arrangement, the sprung roller arms 222 may be integrally moulded or formed with the lid or otherwise attached to the lid structure.

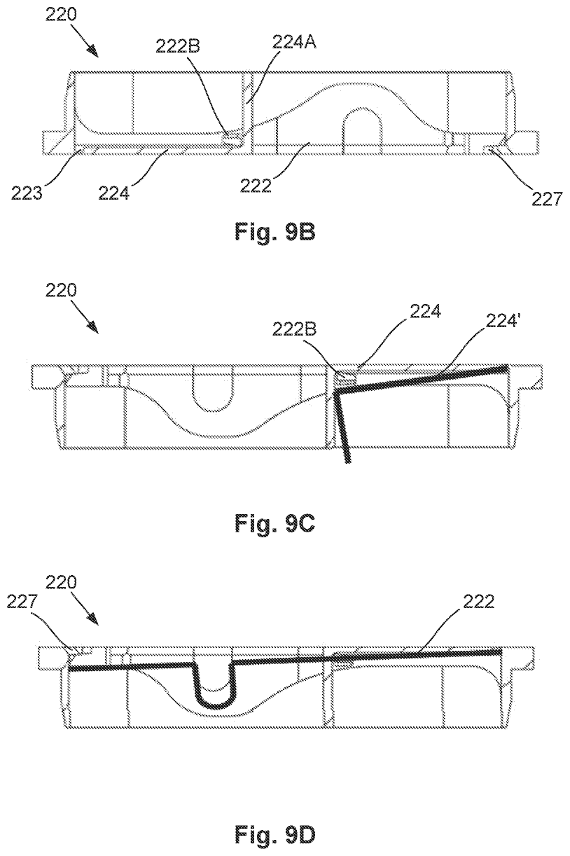

The pair of sprung roller arms 222 are disposed about opposing sides of the container 210. In this manner, the adhesive roller 230 is typically supported proximate opposing ends which allows the roller 230 to rotate. As shown in FIGS. 5B and 9A, the pair of sprung roller arms 222 include a groove or slot 222A into which an axle 231 of the adhesive roller 230 is rotatably coupled.

The components of the adhesive applicator 200 could be made from plastic or metal and in some examples, the container, lid, roller and sprung roller arms may be 3D printed and disposable after use. In one example, the container, lid and/or sprung roller arms are 3D printed plastic components whilst the adhesive roller is metal (i.e. steel).

The adhesive applicator 200 may be adjustably mounted to a support post 30 and bracket or plate assembly 40 which has a series of slots which enables the bracket (and adhesive applicator) to be moved up and down and back and forth as desired. This could be a manual adjustment or via suitable actuators which may be controlled to adjust the relative positioning of the applicator. The adhesive applicator 200 may be mounted onto a tubular support or bar 260 which extends laterally away from bracket 40.

In this regard, the container 210 is typically mounted in a cradle 240 and removably secured thereto. The cradle 240 is mounted to the tube or bar 260. In one example, a heated plate 250 is mounted to the base of the cradle 240 and the container 210 is mounted onto the heated plate 250 so as to control the temperature (and viscosity) of the adhesive in the reservoir 201.

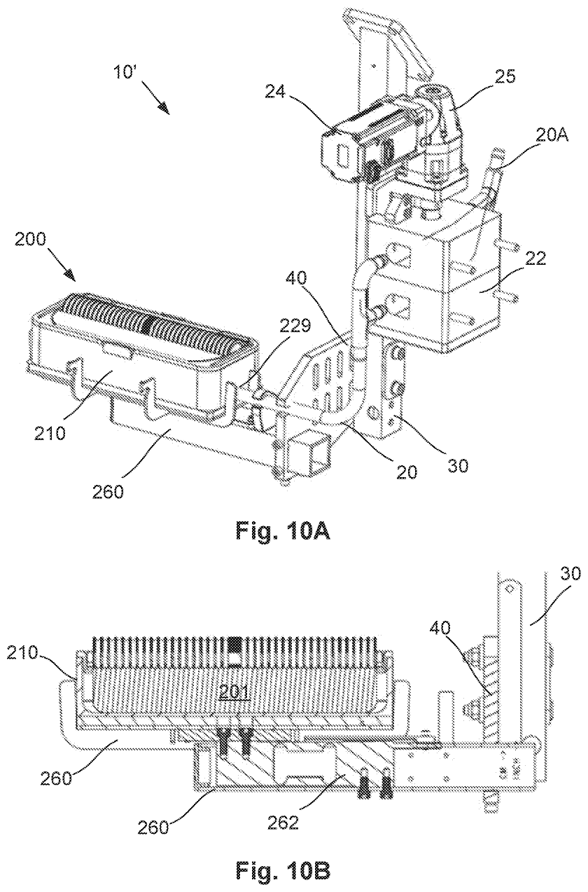

To maintain adhesive levels in the container 210 (to approximately +/2 mm) a load cell 262 is used as best shown in FIG. 10B. The load cell 262 sits beneath the container 210 and provide signal indicative of the mass of the container to a control system which then pumps adhesive into the container to maintain a mass of adhesive (and hence level) between programmable maximum and minimum levels. For the roller to work effectively, it needs to be at least partially submerged in the adhesive. As shown in FIG. 10B, the load cell 262 is positioned beneath the cradle 240 and used to monitor the weight of the adhesive in the reservoir 201 so as to maintain a programmed level of adhesive in the reservoir 201. Another option utilises a non-contact ultrasonic sensor to measure distance to the top of the adhesive or a capacitive sensor to determine a level of adhesive in the container.

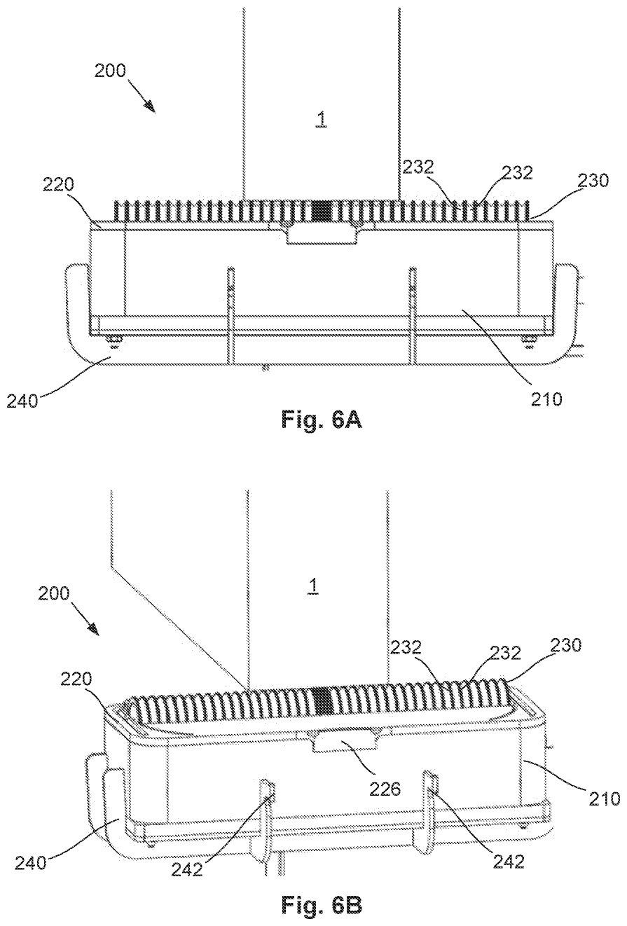

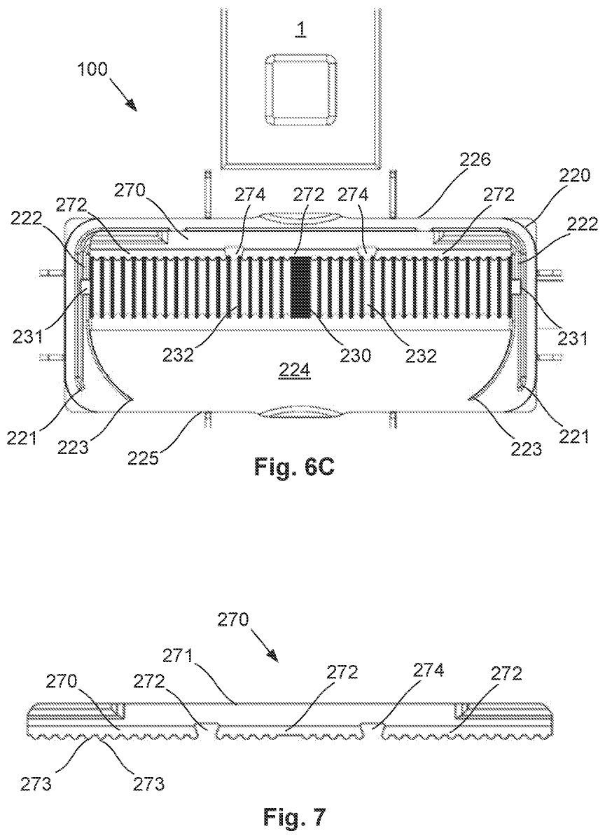

Typically, one or both of the sprung roller arms 222 are coupled to the container 210 by an integral moulding that includes a built-in hinge or pivot 221 (see FIG. 6C) that allows the arms to flex or bend. In this regard, the arms act like flexibly resilient cantilever members. The moulding (which may be the lid 220) typically includes a peripheral slot that allows the moulding to be engaged onto a portion of an upper wall of the container. The built-in hinge or pivot 221 may be defined by a slot in the moulding having a terminal end proximate the base of each arm 222 about which the arm 222 can flex.

The adhesive roller may be provided in numerous forms. In the example shown in FIGS. 5A and 5B, the adhesive roller 230 has an elongate body having a plurality of circumferential grooves 232 spaced apart along the length of the body. Instead of grooves, the roller surface may alternatively be knurled or have some other kind of surface roughness or pattern applied to it which assists in both preventing roller slippage and providing a desired adhesive signature onto the block. In this example, a single roller is provided which extends substantially across the container 210.

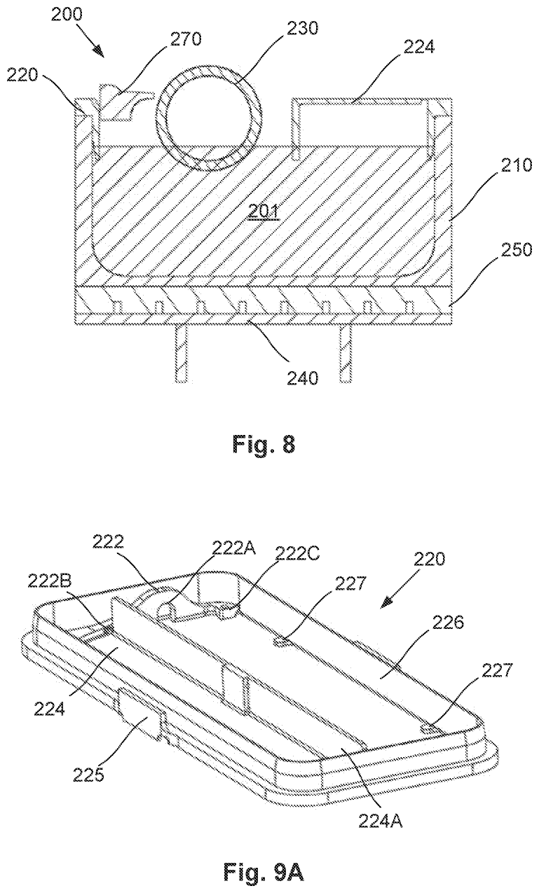

Referring to FIGS. 6A to 6C and FIGS. 7 and 8, an example of a lid 220 is shown in more detail in which a scraper 270 is coupled to the pair of sprung roller arms 222 proximate a distal end thereof (proximate edge 226 of container 210), the scraper 270 having an elongate body 271 defining one or more ridged sections 272 including a plurality of ridges 273 operable to block particular grooves of the adhesive roller 230 and scrape adhesive therefrom. Additionally, one or more voids 274 are positioned between the ridged sections 272, the voids 274 providing areas where adhesive is able to be entrained onto the roller 230 to thereby define a pre-defined adhesive signature. The scraper 270 may be removable and adapted to suit the particular adhesive signature required by selectively allowing adhesive to be entrained onto certain areas of the roller 230. In one example, the scraper 270 is press fit between the distal ends 222C of the sprung roller arms 222. In another example, the lid may act as a mask around the leading edge of the roller, the distance of the edge of the mask away from the roller proportional to the amount of adhesive which is entrained onto the roller. The mask can therefore control the volume of adhesive picked up by the roller and assist in minimising the surface area of adhesive exposed to the environment.

Referring now to FIGS. 9A to 9D, it may be desirable to pre-load or tension the sprung roller arms 222. Once the scraper 270 has been assembled onto the roller arms 222, pre-tensioning may be achieved by manipulating the arms 222 and urging the scraper 270 beneath tabs 227 located along a lengthwise edge of the lid 220 (see FIG. 9D). This provides a pre-load when the roller is in contact with the brick to eliminate roller slippage.

The lid 220 is coupled to the container 210 in order to substantially conceal the reservoir 201. The lid 220 may include a pivotable cover 224 disposed between the pair of sprung roller arms 222 and extending towards the adhesive roller 230. The cover 224 is adapted to hinge about built-in pivot point 223. A distal end 224A of the pivotable cover 224 may be urged beneath tabs 222B disposed on the sprung roller arms 222 as shown in FIG. 9C so as to allow any unused adhesive on the surface of the cover 224 to drain back into the reservoir 201.

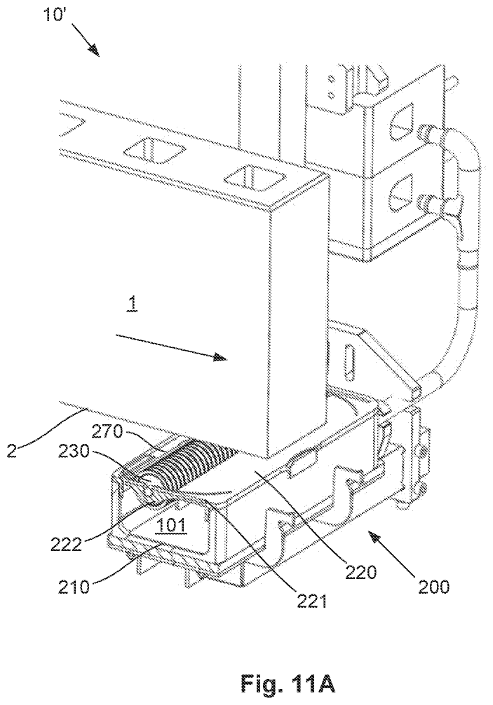

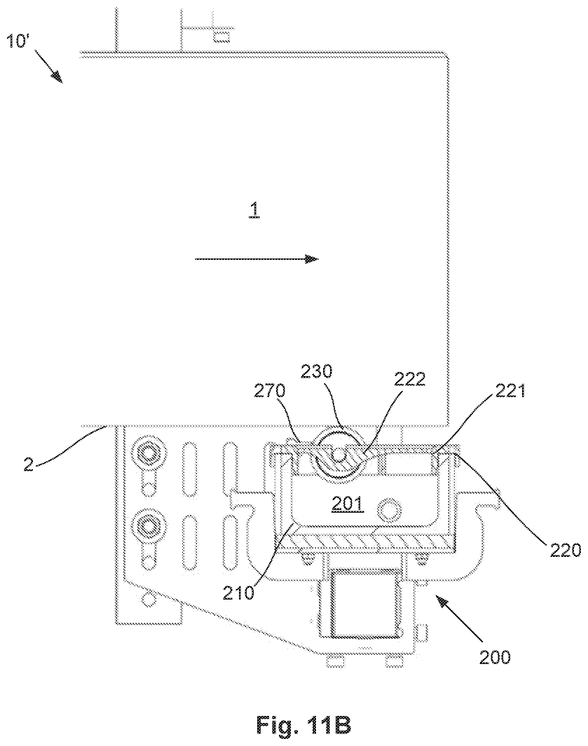

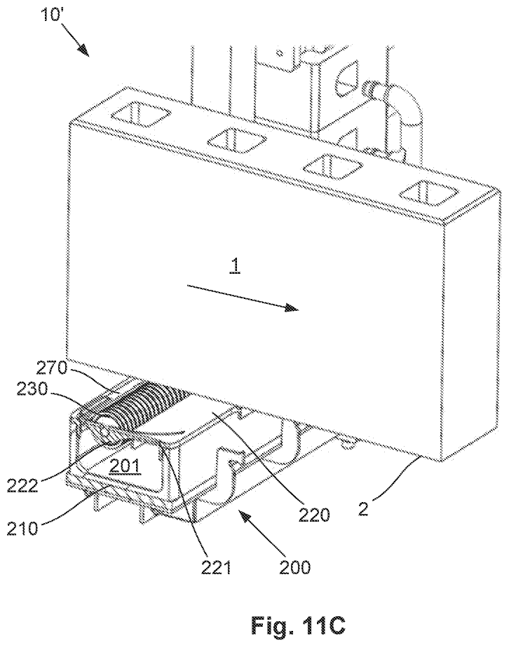

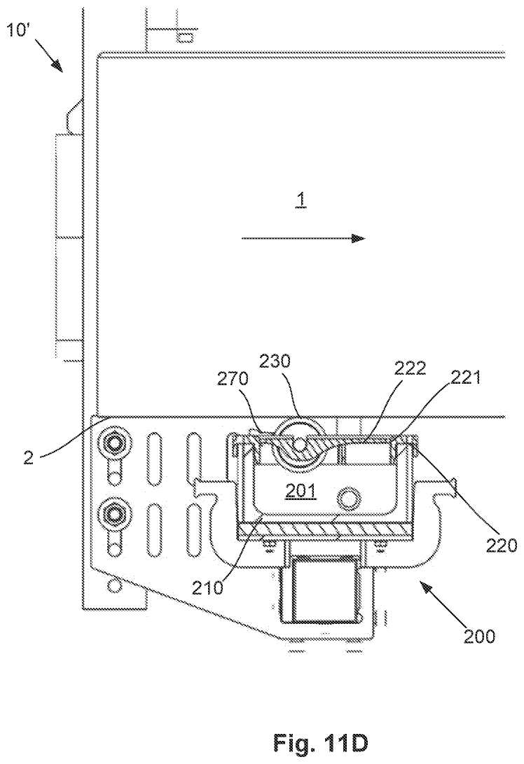

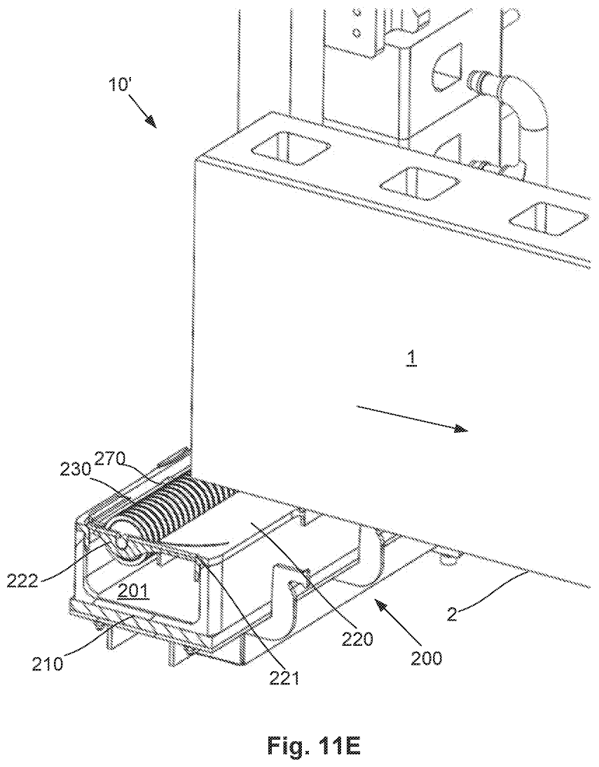

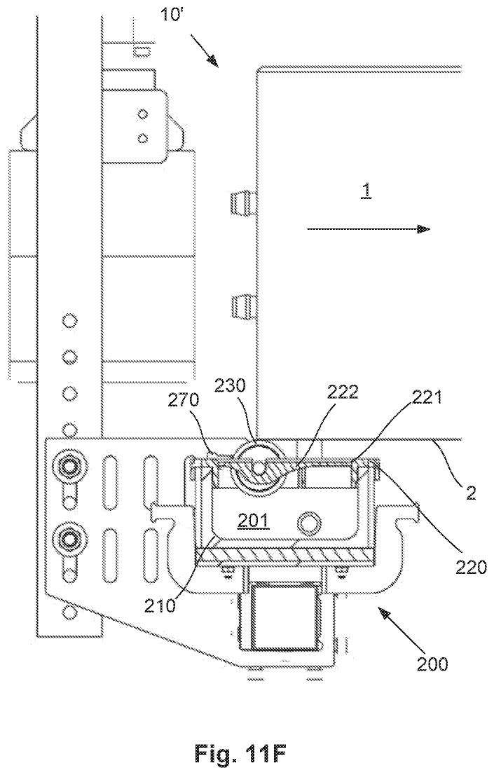

FIGS. 11A to 11H show FIGS. 11A to 11H provide a sequence of views illustrating a block 1 moving across the roller 230 of the adhesive applicator 200 to thereby apply adhesive to the bottom surface 2 of the block 1. In this example, the bottom surface 2 of the block 1 contacts the roller 230 in order to transfer the adhesive entrained on the roller onto the surface of the block. However, in alternative examples, since a laminar bead of adhesive having a thickness is entrained onto the roller, it is not necessary for there to be physical contact between the block and roller and a gap may be provided less than or equal to the thickness of the bead.

As the sprung roller arms 230 are compliant and able to hinge about pivot 221, as the block moves across the top of the roller, the roller may move up and down in a compliant fashion to conform to the block shape which may vary along its length.

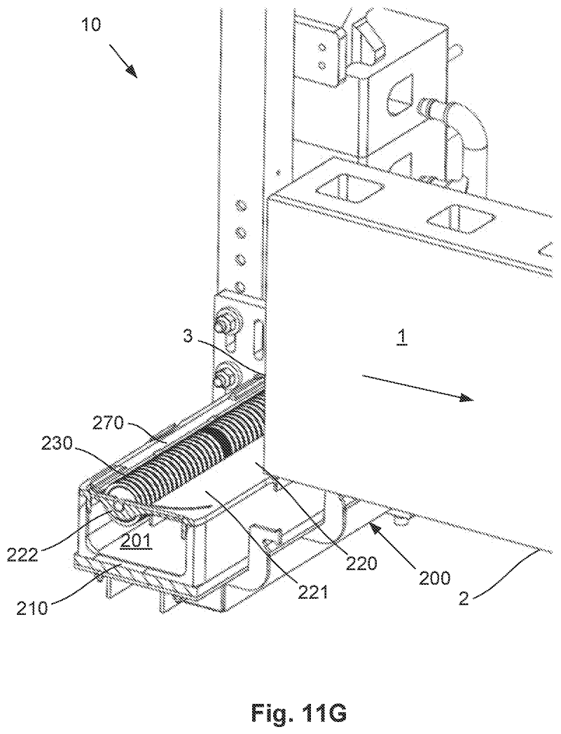

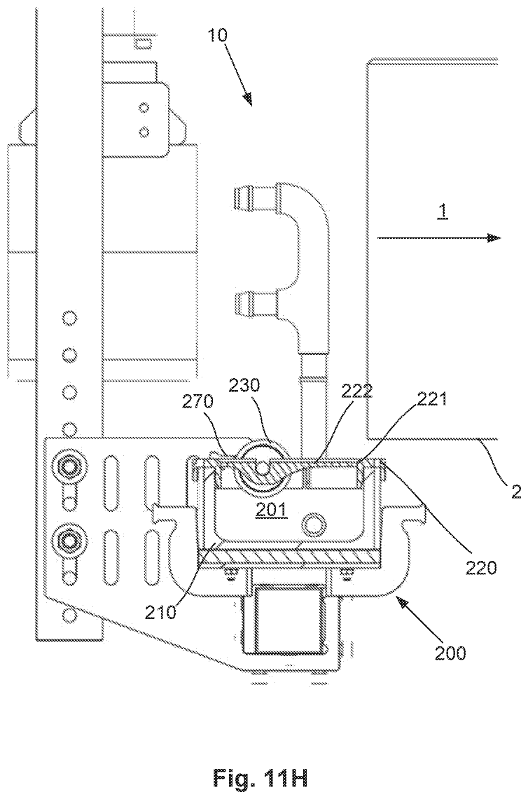

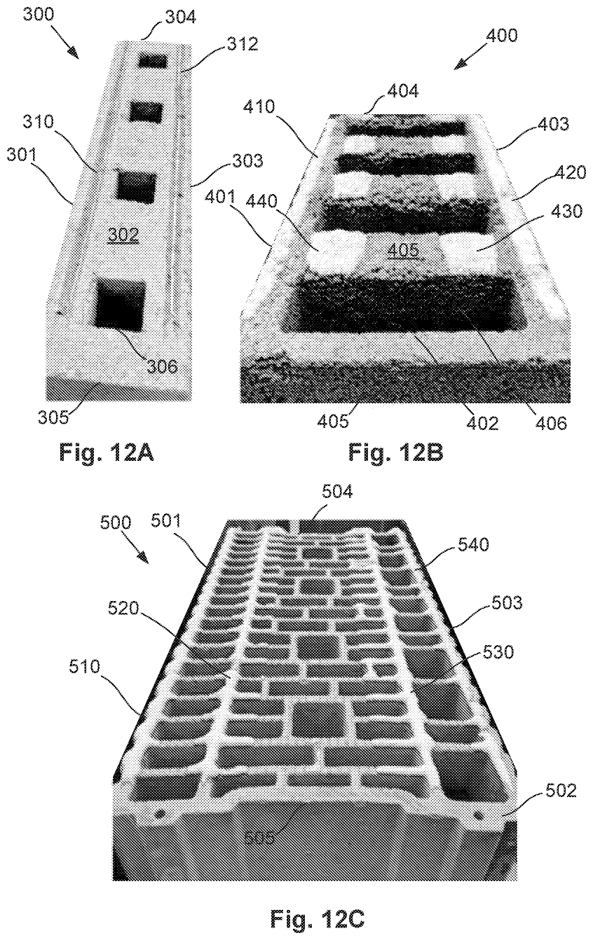

Examples of block adhesive signatures are shown in FIGS. 12A to 12C. In FIG. 12A, a concrete masonry unit (CMU) block 300 is shown of cuboid form having sides 301, 303 and ends 304, 305 and a plurality of cores 306 spaced lengthwise along the block. Two parallel beads of adhesive 301, 312 are applied lengthwise along the bottom surface 302 of the block adjacent sides 301, 303. In FIG. 12B, a slightly wider CMU block 400 is shown having sides 401,403 and ends 404, 405 and a plurality of cores 406 spaced lengthwise along the block. Two parallel beads of adhesive 410, 420 are applied lengthwise along the bottom surface 402 of the block adjacent sides 401, 403. Adhesive is also applied to the ribs between the cores 406 as depicted by beads 430, 440. These additional beads provide greater adhesion across the width of the block for a wider block such as this. Finally, in FIG. 12C a clay block 500 is shown having a complex core arrangement. Block 500 is shown having sides 501, 503 and ends 504, 505 and a plurality of cores 506. Four parallel beads of adhesive 510, 520, 530 and 540 are applied lengthwise along the bottom surface 502 of the block along longitudinal ribs or stiffeners. These different adhesive signatures are formed by rollers having roller elements spaced apart at different intervals with variable roller element widths dependent on block type.

In this regard, the adhesive roller may include an elongate shaft and a plurality of spaced apart roller elements coupled to the shaft. The roller elements are typically cylindrical and include a plurality of circumferential grooves. Optionally, the roller elements may be spaced apart by spacer elements and configured as appropriate in order to obtain the desired adhesive signature for a particular block type.

In yet a further example, the adhesive roller includes alternating roller and spacer elements coupled to the shaft and wherein the spacer elements have a diameter less than the roller elements. In this example, the roller and spacer elements would be thin discs that are arranged so that the spacers act like grooves. In accordance with the above examples, the adhesive roller may be reconfigured using a standard set of roller and/or spacer elements as appropriate in order to achieve a desired adhesive signature.

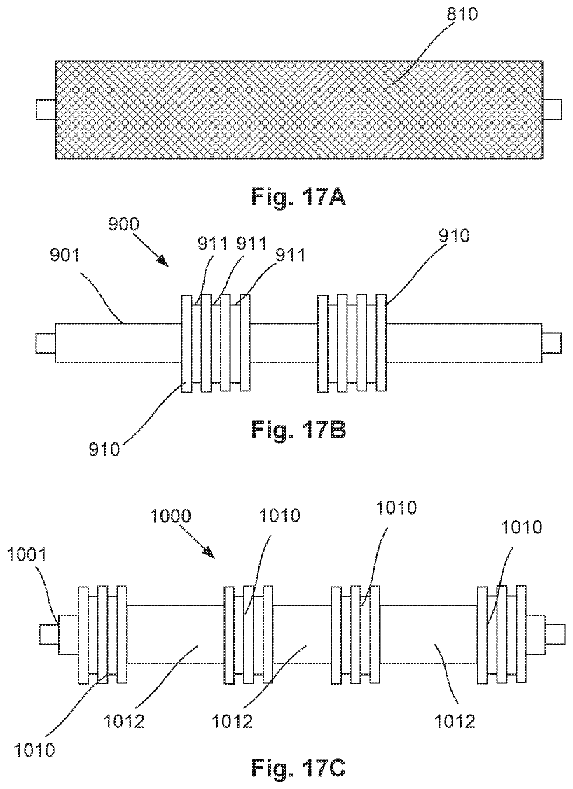

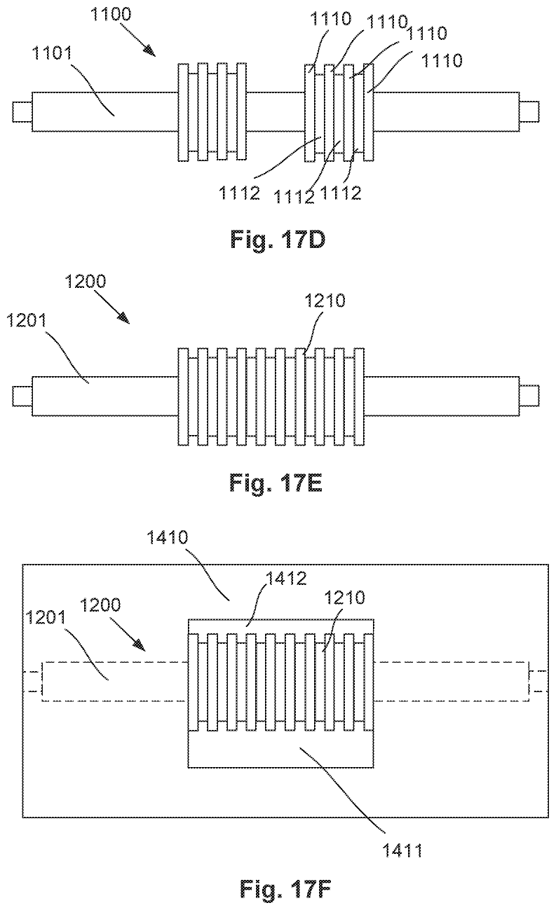

Examples of alternative roller configurations are provided in FIGS. 17A to 17F. In FIG. 17A, there is shown an elongate cylindrical roller having a knurled body 810. In FIG. 17B, there is shown a roller 900 having an elongate shaft 901 and a pair of spaced apart roller elements 910 each with a plurality of spaced circumferential grooves 911. In FIG. 17C, there is shown a roller 1000 having an elongate shaft 1001, and a plurality of spaced apart roller elements 1010 that are separated by spacer tubes 1012. In FIG. 17D, there is shown a roller 1100 having an elongate shaft 1101 and a plurality of thin roller elements 1110 separated by thin spacers 1112. FIG. 17D shows a roller 1200 having an elongate shaft 1201 and a central roller element 1210 which is intended to be masked as shown in FIG. 17E by lid 1410 which acts as a mask around the leading edge 1412 of the roller, the distance of the edge of the mask away from the roller proportional to the amount of adhesive which is entrained onto the roller. The mask can therefore control the volume of adhesive picked up by the roller and assist in minimising the surface area of adhesive exposed to the environment.

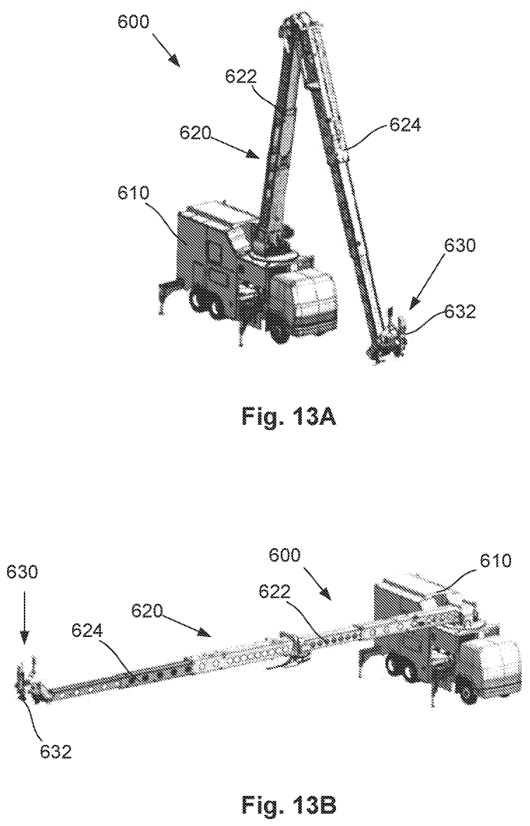

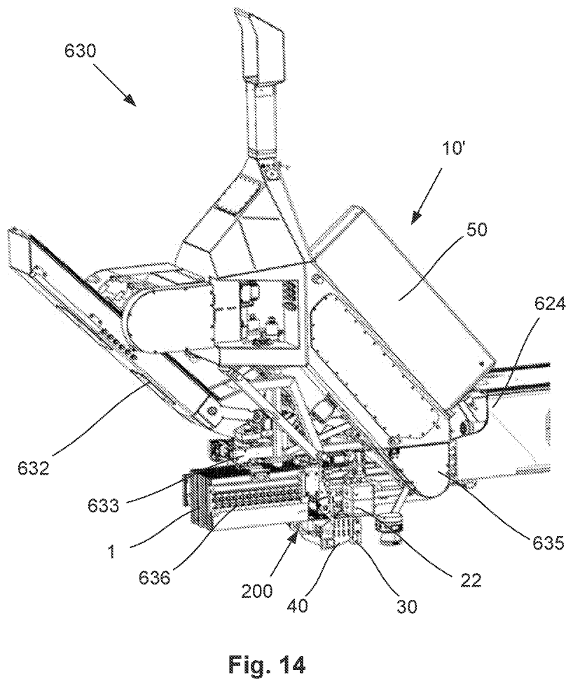

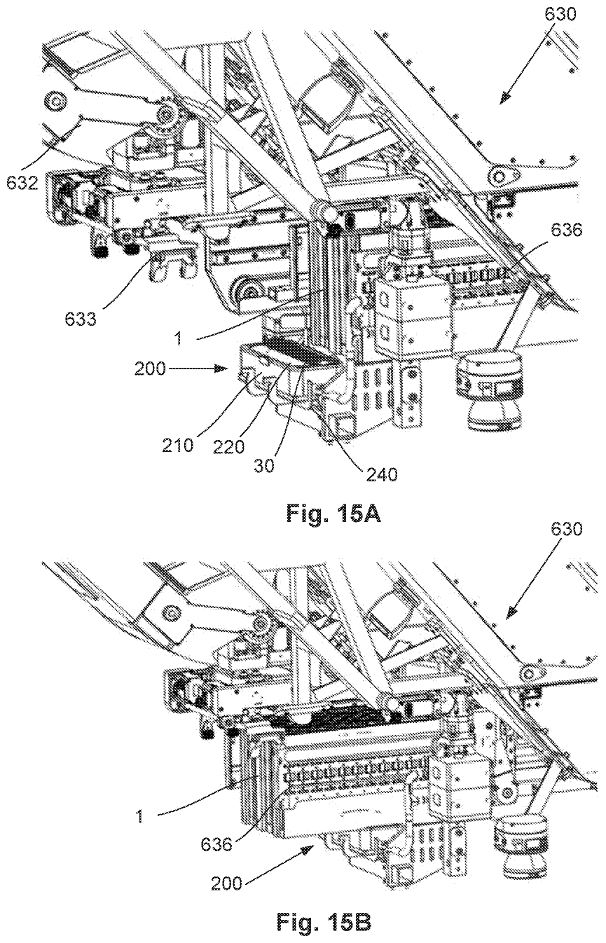

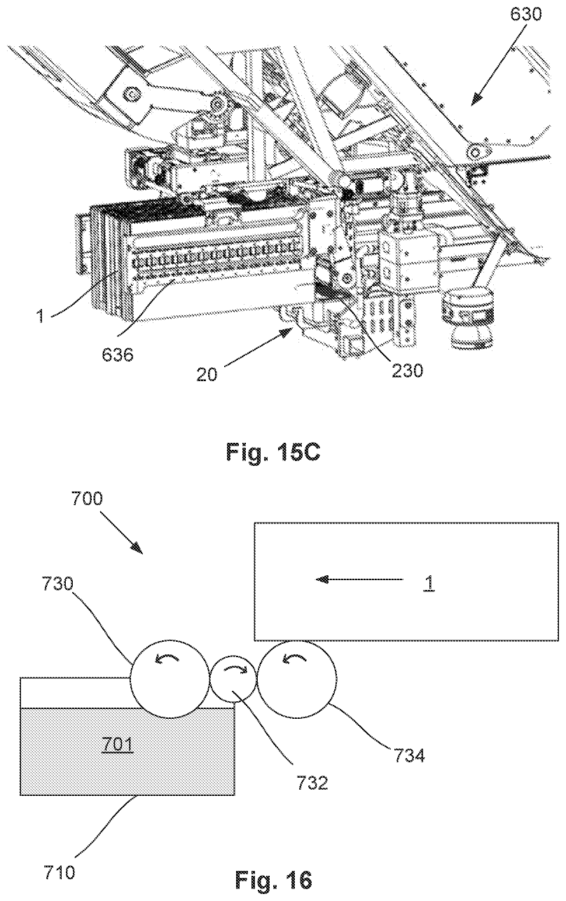

The above described adhesive system is for use with an automated block laying machine 600 as shown in FIGS. 13A and 13B and FIGS. 14 and 15A to 15C. The automated block laying machine 600 may include a base 610 (such as a truck or other vehicle). A telescopically extendable and foldable boom 620 for conveying blocks is rotatably coupled to the base and boom section 622 and 624 are coupled about a pivot joint. A block laying and adhesive applying head 630 is mounted to the distal end of the boom 620 and having a block laying robot arm 632 and end effector 633 for placing a block in a desired position. A block transfer apparatus 636 clamps a block 1 received from the distal end of the boom 620 and linearly extends it across the adhesive applicator 200 mounted to the head 630 as shown in FIGS. 14 and 15A to 15C. The adhesive supply 50 is shown mounted to the side 635 of the head 630. In this way, adhesive is applied to the bottom surface of the block 1 before the laying robot 632 picks up the block and lays it.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers. As used herein and unless otherwise stated, the term “approximately” means±20%.

Persons skilled in the art will appreciate that numerous variations and modifications will become apparent. All such variations and modifications which become apparent to persons skilled in the art, should be considered to fall within the spirit and scope that the invention broadly appearing before described.

1. An adhesive application system for an automated block laying machine, the adhesive application system including:
an adhesive supply; and,
an adhesive applicator including:
a container for storing an adhesive reservoir received from the adhesive supply via an adhesive supply line;
a lid mounted to the container so as to substantially cover the adhesive reservoir; and,
an adhesive roller rotatably coupled to the container and configured to be at least partially submerged in the adhesive reservoir so that upon rotation adhesive from the reservoir is entrained up and around at least a portion of the adhesive roller,
wherein, in use, adhesive is transferred from the adhesive roller onto a bottom surface of a block as the block is moved across the roller.

2. The adhesive application system according to claim 1, wherein adhesive is provided to the adhesive applicator from the adhesive supply via a gravity feed.

3. The adhesive application system according to claim 2, wherein the adhesive supply is a canister having:
an opening to allow the canister to be at least partially filled with adhesive; and,
a removable cap that seals the opening and is configured to be in fluid communication with the adhesive supply line;
wherein, in use, the canister is oriented so that the cap is facing downward and adhesive is able to flow by gravity through the cap and into the supply line.

4. The adhesive application system according to claim 3, wherein the adhesive supply line includes a valve which is openable to allow flow of adhesive into the container of the adhesive applicator.

5. The adhesive application system according to claim 4, wherein the valve is actuated by a motor and controllable to selectively open in order to meter the amount of adhesive supplied to the container.

6. The adhesive application system according to claim 5, wherein the motor is coupled to a reduction gearbox to increase torque for actuating the valve.

7. The adhesive application system according to claim 4, wherein the amount of adhesive in the container is monitored by:
a level sensor that provides a signal to a controller indicative of the level of adhesive in the container; and/or,
a mass sensor that provides a signal to a controller indicative of the mass of the container.

8. The adhesive application system according to claim 7, wherein:
the level sensor is a capacitive sensor mounted to a side of the container; and/or,
the mass sensor is a load cell mounted beneath the container.

9. (canceled)

10. The adhesive application system according to claim 1, wherein:
the adhesive is heated prior to application; and/or,
a heating element is provided at a base of the container.

11. (canceled)

12. The adhesive application system according to claim 1, wherein the adhesive roller includes:
an elongate shaft having axles rotatably coupled to opposing ends of the container; and,
one or more roller elements coupled to or integral with the shaft.

13. The adhesive application system according to claim 12, wherein:
in use, the one or more roller elements are at least partially submerged in the adhesive reservoir, and/or,
the one or more roller elements at least partially protrude above the lid through openings therein.

14. (canceled)

15. The adhesive application system according to claim 12, wherein;
the one or more roller elements are circular discs or wheels; and/or,
the one or more roller elements have at least one circumferential groove formed therein.

16. (canceled)

17. The adhesive application system according to claim 12, wherein the adhesive roller is driven by a motor coupled to the elongate shaft via a coupling element.

18. The adhesive application system according to claim 12, wherein a bead of adhesive is entrained onto the one or more roller elements as the shaft rotates and is transferred onto the block as the block moves across the adhesive roller, wherein one of:
the block contacts the one or more roller elements; and,
there is a gap between the block and the one or more roller elements less than or equal to the thickness of the bead of adhesive.

19. The adhesive application system according to claim 1, wherein the system is mounted to a block laying and adhesive applying head of the automated block laying machine, the head located at a distal end of a telescopingly extendable and foldable boom for conveying blocks therealong.

20. The adhesive application system according to claim 19, wherein the adhesive applicator is adjustably mounted to the head via a support post and bracket.

21. A block laying and adhesive applying head for an automated block laying machine, the head mountable to a distal end of a telescopingly extendable and foldable boom for conveying blocks therealong, the head including an adhesive application system including:
an adhesive supply; and,
an adhesive applicator including:
a container for storing an adhesive reservoir received from the adhesive supply via an adhesive supply line;
a lid mounted to the container so as to substantially cover the adhesive reservoir; and,
an adhesive roller rotatably coupled to the container and configured to be at least partially submerged in the adhesive reservoir so that upon rotation adhesive from the reservoir is entrained up and around at least a portion of the adhesive roller,
wherein, in use, adhesive is transferred from the adhesive roller onto a bottom surface of a block as the block is moved across the roller.

22. The block laying and adhesive applying head according to claim 21, wherein the head includes a block transfer apparatus for transferring a block from a distal end of the boom to a robotic arm having an end effector which grips and lays the block at a predetermined spatial position and orientation, the block transfer apparatus configured to clamp the block and linearly extend it across the adhesive roller before it is transferred to the robotic arm and laid.

23. The block laying and adhesive applying head according to claim 21, the head further including:
a support mountable to the boom, wherein the adhesive application system is mounted to the support;
a robotic arm having an end effector operable to grip and lay blocks at a predetermined spatial position and orientation; and,
a block transfer apparatus for transferring a block from the distal end of the boom to the robotic arm,
wherein, in use, adhesive is transferred from the adhesive roller onto the bottom surface of the block as the block transfer apparatus linearly extends the block across the roller.

24. An automated block laying machine, including:
a base;
a telescopingly extendable and foldable boom rotatably mounted from the base for conveying blocks therealong; and,
a block laying and adhesive applying head, the head mountable to a distal end of the boom, the head including:
a support mountable to the boom;
a robotic arm having an end effector operable to grip and lay blocks at a predetermined spatial position and orientation;
a block transfer apparatus for transferring a block from the distal end of the boom to the robotic arm; and,
an adhesive application system mounted to the support including:
an adhesive supply; and,
an adhesive applicator including:
a container for storing an adhesive reservoir received from the adhesive supply via an adhesive supply line;
a lid mounted to the container so as to substantially cover the adhesive reservoir; and,
an adhesive roller rotatably coupled to the container and configured to be at least partially submerged in the adhesive reservoir so that upon rotation adhesive from the reservoir is entrained up and around at least a portion of the adhesive roller,
wherein, in use, adhesive is transferred from the adhesive roller onto a bottom surface of a block as the block transfer apparatus linearly extends a block across the roller.
